(19) United States
(12) Patent Application Publication
(10) Pub. No.: US 2021/0304616 A1
(43) Pub. Date: Sep. 30, 2021

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Ayano OKOSO, Nagakute-shi (JP); Tomoki NISHI, Nagakute-shi (JP); Keisuke OTAKI, Nagakute-shi (JP); Keiichiro HAYAKAWA, Nagakute-shi (JP); Takayoshi YOSHIMURA, Nagakute-shi (JP); Yoshinao ISHII, Nagakute-shi (JP); Takahiro SHIGA, Nagakute-shi (JP)

(73) Assignee: TOYOTA JIDOSHA KABUSHIKI KAISHA, Toyota-shi (JP)

(21) Appl. No.: 17/210,834

(22) Filed: Mar. 24, 2021

(30) Foreign Application Priority Data
Mar. 27, 2020 (JP) 2020-057946

(51) Int. Cl. G08G 1/00; G08G 1/01; G06Q 50/30; G06Q 10/02

(52) U.S. Cl. CPC G08G 1/202; G08G 1/0141; G06Q 10/02; G08G 1/0129; G06Q 50/30; G08G 1/207

(57) ABSTRACT

When an information processing apparatus disclosed receives a signal requesting dispatch of a taxi with information about a desired location of getting-in, it determines a recommended location of getting-in on the basis of at least one of information about a physical condition relating to a road in a specific area including the desired location of getting-in, information about instances of users' getting in and/or getting out of taxis that took place in the specific area in the past, and information about a condition of the road in the specific area. The information processing apparatus sends information for inviting a user to wait at the recommended location of getting-in determined as above to a user's terminal used by the user.

### CROSS REFERENCE TO THE RELATED APPLICATION

This application claims the benefit of Japanese Patent Application No. 2020-057946, filed on Mar. 27, 2020, which is hereby incorporated by reference herein in its entirety.

### BACKGROUND

### Technical Field

The present disclosure relates to an information processing apparatus, an information processing method, and a non-transitory storage medium.

### Description of the Related Art

There are prevailing taxi dispatch application programs that can run on user's terminals such as smartphones. Such application programs will also be referred to as “taxi dispatch applications” hereinafter. When receiving a request for dispatch of a taxi by a user, a known system using a taxi dispatch application according to a prior art informs the user's terminal of the present location of a taxi and a planned travel route from its present location to a location at which the taxi will pick up the user (see, for example, Patent Literature 1 in the citation list below).

### CITATION LIST

### Patent Literature

Patent Literature 1: Japanese Patent Application Laid-Open No. 2015-138324

### SUMMARY

An object of this disclosure is to provide a technology that can improve efficiency of taxi dispatch.

Disclosed herein is an information processing apparatus. The information processing apparatus may comprise, for example, a controller including at least one processor,

the controller configured to execute the processing of

receiving a dispatch request signal from a user's terminal used by a user, the dispatch request signal being a signal requesting dispatch of a taxi and containing information about a desired location of getting-in at which the user wishes to get in a taxi;

determining a recommended location of getting-in on the basis of at least one of physical condition information defined as information about a physical condition relating to a road in a specific area including the desired location of getting-in, past instance information defined as information about instances of users' getting in and/or getting out of taxis that took place in the specific area in the past, and road information defined as information about a condition of the road in the specific area; and

sending getting-in location information to the user's terminal, the getting-in location information being information for inviting the user to wait at the recommended location of getting-in.

Also disclosed herein is an information processing method. The information processing method may comprise the following steps of processing executed by a computer:

receiving a dispatch request signal from a user's terminal used by a user, the dispatch request signal being a signal requesting dispatch of a taxi and containing information about a desired location of getting-in at which the user wishes to get in a taxi;

determining a recommended location of getting-in on the basis of at least one of physical condition information defined as information about a physical condition relating to a road in a specific area including the desired location of getting-in, past instance information defined as information about instances of users' getting in and/or getting out of taxis that took place in the specific area in the past, and road information defined as information about a condition of the road in the specific area; and

sending getting-in location information to the user's terminal, the getting-in location information being information for inviting the user to wait at the recommended location of getting-in.

Also disclosed herein is an information processing program for causing a computer to implement the above information processing method or a non-transitory storage medium in which such an information processing program is stored.

This disclosure provides a technology that can improve efficiency of taxi dispatch.

### BRIEF DESCRIPTION OF THE DRAWINGS

FIG. 1 is a diagram illustrating an exemplary configuration of a taxi dispatch system.

FIG. 2 is a diagram illustrating an exemplary configuration of a taxi.

FIG. 3 is a diagram illustrating exemplary hardware configurations of an on-vehicle apparatus, a user's terminal, and a server apparatus.

FIG. 4 is a block diagram illustrating an exemplary functional configuration of the server apparatus according to an embodiment.

FIG. 5 illustrates an exemplary structure of a physical condition information table according to the embodiment.

FIG. 6 illustrates an exemplary structure of a past instance information table according to the embodiment.

FIG. 7 illustrates an exemplary structure of a taxi information table according to the embodiment.

FIG. 8 is a flow chart of a process executed by the server apparatus according to the embodiment.

FIG. 9 is a block diagram illustrating an exemplary functional configuration of the server apparatus according to a fifth modification of the embodiment.

FIG. 10 illustrates an exemplary structure of a past temporary instance information table according to the fifth modification of the embodiment.

FIG. 11 is a flow chart of a process executed by the server apparatus according to the fifth modification.

### DESCRIPTION OF THE EMBODIMENTS

The technology disclosed herein is characterized by optimizing the location at which a user of a taxi dispatch service gets in a taxi, to thereby enable efficient taxi dispatch. In the following description, the term “a taxi/taxis” shall refer to an empty taxi/taxis, unless stated otherwise.

When a request for dispatch of a taxi is made by a user, ordinary systems of providing taxi dispatch service (which will also be referred to as “taxi dispatch systems” hereinafter) generally dispatch a taxi to a location at which the user wishes to get in the taxi. This location will be hereinafter referred to as the “desired location of getting-in” hereinafter. The desired location of getting-in may be, for example, the present location of the user or a place designated by the user (other than the present location).

Desired locations of getting-in are not always appropriate locations for users to get in taxis. For example, if there is a partition, such as a guardrail, planting or something, between the desired location of getting-in and the road, or the desired location of getting-in is facing a no-parking or no-stopping zone, it may be physically impossible for the user to get in the taxi at the desired location of getting-in. In such cases, it is necessary for the user and the taxi to move to a place with nothing that partitions the place and the road and not facing a no-parking or no-stopping zone. Furthermore, there may be cases where a vehicle is parked on the portion of the road adjacent to the desired location of getting-in to prevent the taxi from accessing the desired location of getting-in. In such cases also, it is necessary for the user and the taxi to move to a place where there is no parked vehicle on the adjacent road. Still further, if there are traffic restrictions due to construction or other reasons in the road near the desired location of getting-in, the taxi cannot access the desired location of getting-in in some cases. In such cases also, it is necessary for the user and the taxi to move to a place around which there are no traffic restrictions. In cases where there is a traffic jam in a road along which the taxi travels to access the desired location of getting-in (which will also be referred to as “access road”), it may take time for the taxi to travel to the desired location of getting-in. This can lead to an unduly long waiting time for the user or an unduly long time of travel that does not produce income for the taxi. In cases where a gathering to which many people come (such as a sporting event, a concert, an exhibition, or a festival) is being held in a place near the desired location of getting-in, people who wish to take taxis may concentrate in the area around the desired location of getting-in. In such cases, many taxis may gather in the area near the desired location of getting-in. This can prevent the dispatched taxi from quickly accessing the desired location of getting-in.

If the desired location of getting-in is not an appropriate place for the user to get in the taxi due to some reasons as described above, it may be difficult for the user to get in the taxi smoothly. Such situations can lead to inconvenience of the user or require increased effort of the taxi driver. This can make efficient dispatch of taxis difficult.

An information processing apparatus disclosed herein is intended to solve the above problem. When the information processing apparatus receives a signal requesting dispatch of a taxi (which will be hereinafter referred to as “dispatch request signal”), a controller of the information processing apparatus determines a recommended location of getting-in and sends information about the recommended location of getting-in determined to the relevant user's terminal. This information will be hereinafter referred to as “getting-in location information”. The dispatch request signal is a signal sent by a user to request dispatch of a taxi. The dispatch request signal contains information about a location at which the user wished to get in a taxi (i.e. the desired location of getting-in). The recommended location of getting-in is a location appropriate for the user to get in a taxi. The recommended location of getting-in is determined based on at least one of “physical condition information”, “past instance information”, and “road information” described in the following. The physical condition information is information about physical conditions of road in a specific area including the desired location of getting-in. The past instance information is information about instances of users' getting in and/or getting out of taxis that took place in the specific area in the past. The road information is information about the road condition in the specific area. The aforementioned getting-in location information is information used to request the user to wait for the arrival of a taxi at the recommended location of getting-in. The user receives this getting-in location information and waits for the arrival of a taxi at the recommended location of getting-in, so that the user can get in the taxi smoothly. This can prevent inconvenience of the user or increased effort of the taxi driver from being incurred. Therefore, a taxi can be dispatched efficiently.

The physical condition information defined in this disclosure may include at least one of information about places where there is a partition that separates the road and the sidewalk in the specific area and information about no-stopping and/or no-parking zones in the specific area. Thus, it is possible to distinguish between places where it is physically possible for the user to get in a taxi and places where it is not physically possible for the user to get in a taxi in the specific area. With the above information, it is possible to determine whether or not the desired location of getting-in is a place where it is physically possible for the user to get in a taxi. Moreover, it is possible to determine places in the specific area where it is physically possible for the user to get in a taxi.

The past instance information defined in this disclosure may include information about “places of past instances” and information about the “numbers of instances”. The term “places of past instances” refers to places in the specific area where instances of users' getting in and/or getting out of taxis actually took place in the past. The term “numbers of instances” refers to the numbers of instances of users' getting in and/or getting out of taxis that actually took place at the respective places of past instances in the past. The places of past instances may be considered to be places where users can get in or out of a taxi. In particular, places of past instances with large numbers of instances may be considered to be places convenient for users to get in or out of taxis or places convenient for the drivers of taxis to pick up or drop off users. Therefore, based on the above information, it is possible to determine whether or not the desired location of getting-in is convenient for the user to get in or out of a taxi. It is also possible to determine places in the specific area that are convenient for users to get in or out of taxis.

The road information defined in this disclosure may include at least one of information about traffic jams in the roads in the specific area, information about whether or not there is a vehicle parked in the specific area, information about traffic restrictions in the roads in the specific area, and information about whether or not a gathering is being held in the specific area. With such information, it is possible to determine whether or not there is a traffic jam in an access road to the desired location of getting-in. It is also possible to determine whether or not there is a vehicle(s) parked in the portion of the road adjacent to the desired location of getting-in. It is also possible to determine whether or not a gathering is being held at some place near the desired location of getting-in. Moreover, it is possible to determine whether or not there are traffic restrictions in an access road to the desired location of getting-in. In consequence, it is possible to determine whether a taxi can access the desired location of getting-in quickly on the basis of the results of the above determinations. Moreover, it is possible to determine places in the specific area where there is no traffic jam, there is no parked vehicle, or it is easy for the user to get in a taxi during the period when a gathering is being held.

The controller may determine whether or not the desired location of getting-in is an appropriate place for the user to get in a taxi on the basis of at least one of the physical condition information, the past instance information, and the road information. For example, if there is no partition that separates the desired location of getting-in and the road, the desired location of getting-in is not adjacent to any no-stopping or no-parking zone, and there is no vehicle parked in the portion of the road adjacent to the desired location of getting-in, it may be determined that the desired location of getting-in is an appropriate place for the user to get in a taxi. Alternatively, it may be determined that the desired location of getting-in is an appropriate place for the user to get in a taxi if at least one of the following two conditions is met in addition to the above conditions.

Condition 1: there is no traffic jam in any access road to the desired location of getting-in

Condition 2: there are no traffic restrictions in any access road to the desired location of getting-in

In the case where it is determined that the desired location of getting-in is an appropriate place for the user to get in a taxi, the controller may determine the desired location of getting-in as the recommended location of getting-in. In this case, the user will be able to get in a taxi smoothly at the desired location of getting-in.

If it is determined that the desired location of getting-in is not an appropriate place for the user to get in a taxi, the recommended location of getting-in may be selected from among the places allowing getting-in in the specific area, namely the places in the specific area where there is no partition that separates the places and the road and there is no vehicle parked in the portion of the road adjacent to the places and that are not facing a no-parking or no-stopping zone. In determining the recommended location of getting-in, the controller may select the place among the places allowing getting-in at which the number of instances is largest as the recommended location of getting-in. The recommended location of getting-in determined in this way is a place where it is physically possible for the user to get in a taxi and that is accessible for a taxi and convenient for the user to get in or out of a taxi. If the user waits at the recommended location of getting-in determined in this way, the user can get in a taxi smoothly with reliability. If there is a traffic jam or traffic restrictions in an access road to the place at which the number of instances is largest, the place with the second largest number of instances may be determined as the recommended location of getting-in.

In the case where it is determined that the desired location of getting-in is not an appropriate place for the user to get in a taxi, the controller may select the place with the least traffic jam among the aforementioned places allowing getting-in as the recommended location of getting-in. Thus, a place where it is physically possible for the user to get in a taxi and that a taxi can access quickly is determined as the recommended location of getting-in. If the user waits at the recommended location of getting-in determined in this way, the user can get in a taxi smoothly with reliability.

In the case where it is determined that the desired location of getting-in is not an appropriate place for the user to get in a taxi, the controller may select the recommended location of getting-in from among locations allowing getting in that are closer to the desired location of getting-in when the weather is bad than when the weather is fine. For example, when the weather is bad, the recommended location of getting-in may be selected from the places allowing getting-in located in an area smaller than the specific area. This smaller area is an area including the desired location of getting-in. If the recommended location of getting-in is determined in this way, the distance over which the user is obliged to walk in bad weather can be made as small as possible in the case where the desired location of getting-in is not an appropriate place for the user to get in a taxi.

There may be cases where the information processing apparatus receives a plurality of dispatch request signals that specify desired locations of getting-in included in a specific area in a short period of time. In such cases, if the recommended locations of getting-in determined in response to at least two of the plurality of dispatch request signals coincide with each other, it can be difficult for the users to get in taxis smoothly at the recommended location of getting-in. To avoid such situations, the controller may determine different recommended locations of getting-in in response to a plurality of dispatch request signals. Thus, even in the case where the information processing apparatus receives a plurality of dispatch request signals designating desired locations of getting-in included in the specific area in a short period of time, it is possible to allow the users associated with the dispatch request signals to get in taxis smoothly.

The dispatch request signal mentioned in this disclosure may contains information about a destination to which the user wishes to go in addition to information about the desired location of getting-in. In this connection, the controller may determine the recommended location of getting-in on the basis of the direction of traffic of lanes that is convenient for a taxi to travel from the specific area to the destination in addition to the physical condition information, the past instance information, and the road information. For example, the controller may determine as the recommended location of getting-in a place among the places allowing getting-in that is facing a lane having a traffic direction convenient for the a taxi to travel from the specific area to the destination. Such a lane will also be referred to as an appropriate lane. If there are a plurality of places among the places allowing getting-in that are facing an appropriate lane, the controller may determine as the recommended location of getting-in the place with the largest number of instances, the place with the least traffic jam in the access road thereto, a place with no traffic restrictions in the access road thereto, or the place closest to the desired location of getting-in. This eliminates the need for U-turn of the taxi after the user gets in it, thereby preventing unnecessary increase in the fare.

The information processing apparatus disclosed herein may further has a storage unit in which information about a facility located in a specific area where a gathering can be held and information about “places of past temporary instances” are stored in a linked manner. The term “places of past temporary instances” refers to places where instances of users' getting in and/or getting out of taxis actually took place during the period(s) in which a gathering(s) was (were) held in the past. During the period in which a gathering is being held in the facility, the controller may select the recommended location of getting-in from among the places of past temporary instances. In this connection, the controller may determine as the recommended location of getting-in the place with the largest number of instances among the places of past temporary instances, the place closest to the desired location of getting-in among the places of past temporary instances, the place with the least traffic jam in the access road thereto among the places of past temporary instances, or a place of past temporary instances with no traffic restrictions in the access road thereto. Thus, even during the period in which a gathering is being held in the facility in the specific area, a place where the user can get in or out of a taxi easily and that a taxi can access easily is determined as the recommended location of getting-in.

In the following, a specific embodiment of the technology disclosed herein will be described with reference to the drawings. It should be understood that the dimensions, materials, shapes, relative arrangements, and other features of the components that will be described in connection with the embodiments are not intended to limit the technical scope of the disclosure only to them, unless otherwise stated.

### Embodiment

A taxi dispatch system to which the technology disclosed herein is applied will be described in the following as an embodiment.

(General Configuration of Taxi Dispatch System)

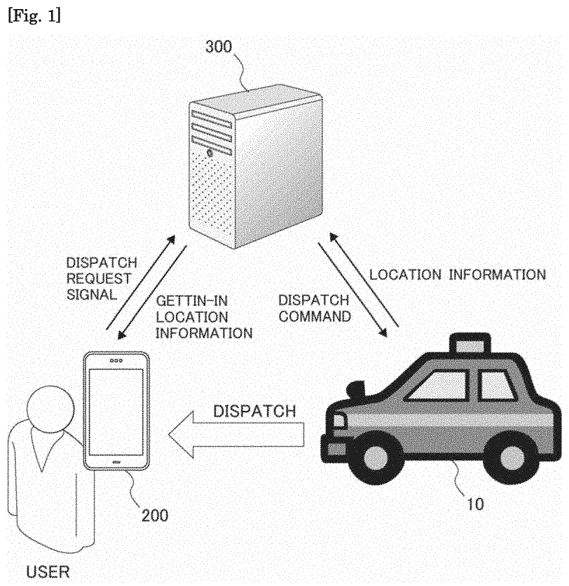

FIG. 1 is a diagram illustrating an exemplary configuration of a taxi dispatch system. The taxi dispatch system illustrated in FIG. 1 includes a taxi 10, a user's terminal 200, and a server apparatus 300. While FIG. 1 shows only one taxi 10 and only one user's terminal 200 for the sake of simplicity, the system actually includes a plurality of taxis 10 and user's terminals 200.

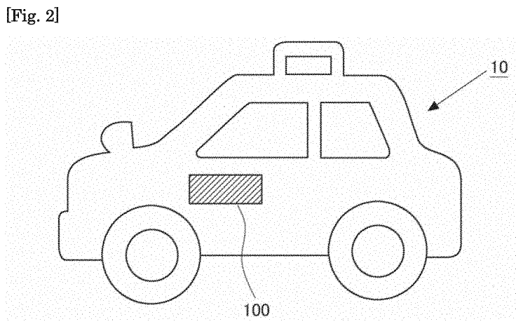

As illustrated in FIG. 2, the taxi 10 is equipped with an on-vehicle apparatus 100. The on-vehicle apparatus 100 is capable of determining the present location of the taxi 10 equipped with the on-vehicle apparatus 100. The on-vehicle apparatus 100 sends information about the present location determined (location information) to the server apparatus 300 with identification information (or vehicle ID) of the taxi 10 equipped with the on-vehicle apparatus 100. The on-vehicle apparatus 100 determines the present location and sends the location information repeatedly at regular intervals. Alternatively, the on-vehicle apparatus 100 may determine the present location and send the location information in response to a request from the server apparatus 300.

The on-vehicle apparatus 100 provides route guidance to the driver on the basis of a dispatch command sent from the server apparatus. The dispatch command in the system according to this embodiment contains information about a location at which a user will get in the taxi 10 (i.e. recommended location of getting-in) and information about a planned route of travel from the present location of the taxi 10 to the recommended location of getting-in. The on-vehicle apparatus 100 provides guidance of the route from the present location of the taxi 10 to the recommended location of getting-in according to the dispatch command.

The user's terminal 200 is a computer used by a user who requests dispatch of a taxi 10. In the user's terminal 200 is installed a taxi dispatch application, namely an application for using the taxi dispatch service. The user can request dispatch of a taxi 10 by causing the taxi dispatch application to run on the user's terminal 200. When a request for dispatch of a taxi 10 is made by the user, the user's terminal 200 sends a dispatch request signal containing information about a desired location of getting-in at which the user wishes to get in a taxi to the server apparatus 300. The desired location of getting-in may be the present location of the user or a location other than the present location that the user designates at will. The dispatch request signal may contain information about a destination of the user (i.e. a location at which the user will get out of the taxi 10).

The user's terminal 200 in the system according to this embodiment executes the processing of inviting the user to wait for the arrival of a taxi 10 at the recommended location of getting-in according to getting-in location information sent from the server apparatus 300. In other words, the user's terminal 200 executes the processing of inviting the user to get in the taxi 10 at the recommended location of getting-in. The getting-in location information mentioned above is information sent from the server apparatus 300 to the user's terminal 200 in response to the dispatch request signal. The getting-in information contains information for inviting the user to wait at the recommended location of getting-in. The recommended location of getting-in is a location appropriate for the user to get in a taxi 10. The recommended location of getting-in is set at or near the desired location of getting-in.

The server apparatus 300 constitutes the information processing apparatus according to this disclosure. The server apparatus 300 executes the processing of determining the recommended location of getting-in, the processing of dispatching a taxi 10 according to the recommended location of getting-in, and the processing of sending the getting-in location information to the user's terminal 200 in response to the dispatch request signal sent from the user's terminal 200. When receiving the dispatch request signal, the server apparatus 300 in the system of this embodiment firstly determines the recommended location of getting-in. Specifically, the server apparatus 300 determines whether or not the desired location of getting-in is an appropriate place for the user to get in a taxi 10. If it is determined that the desired location of getting-in is an appropriate place for the user to get in a taxi 10, the server apparatus 300 sets the recommended location of getting-in at the desired location of getting-in. If it is determined that the desired location of getting-in is not an appropriate place for the user to get in a taxi 10, the server apparatus 300 sets the recommended location of getting-in at a location in a specific area including the desired location of getting-in that is appropriate for the user to get in a taxi 10. The specific area mentioned above is an area over which the user can move easily on foot, which may be, for example, an area within a range of several meters or several tens of meters from the desired location of getting-in. After determining the recommended location of getting-in, the server apparatus 300 executes the processing of dispatching a taxi 10. Specifically, the server apparatus 300 finds the taxi 10 located closest to the recommended location of getting-in on the basis of location information received form the on-vehicle apparatuses 100 of the taxis 10. Then, the server apparatus 300 determines a planned route of travel from the present location of the taxi 10 thus found to the recommended location of getting-in. Then, the server apparatus 300 sends a dispatch command containing information about the recommended location of getting-in and information about the planned route of travel to the on-vehicle apparatus 100 of the taxi 10 found as above. Moreover, the server apparatus 300 sends information for inviting the user to wait at the recommended location of getting-in determined as above (i.e. getting-in location information) to the user's terminal 200.

(Hardware Configuration)

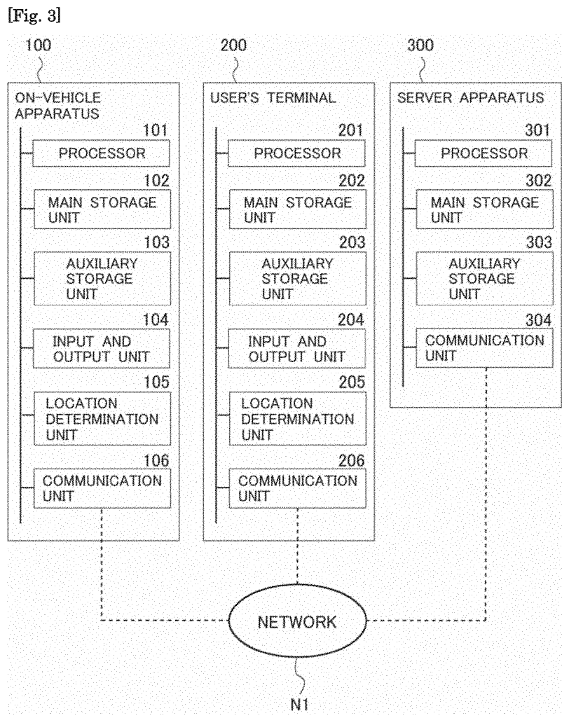

FIG. 3 is a diagram illustrating exemplary hardware configurations of the on-vehicle apparatus 100, the user's terminal 200, and the server apparatus 300. While FIG. 3 shows only one on-vehicle apparatus 100, every taxi 10 that is under the management of the server apparatus 300 is equipped with an on-vehicle apparatus 100 having the same hardware configuration as the on-vehicle apparatus 100 illustrated in FIG. 3. Every user's terminal in which the taxi dispatch application is installed has the same hardware configuration as the user's terminal 200 illustrate in FIG. 3.

The on-vehicle apparatus 100 is, for example, a car navigation system that can be connected to a network N1. The on-vehicle apparatus 100 may be a personal computer connected to the network N1. Alternatively, the on-vehicle apparatus 100 may be a small computer that can be carried by the driver of the taxi 10, examples of which include a smartphone, a cellular phone, a tablet terminal, a personal information terminal, and a wearable computer (such as a smartwatch).

As illustrated in FIG. 3, the on-vehicle apparatus 100 has a processor 101, a main storage unit 102, an auxiliary storage unit 103, an input and output unit 104, a location determination unit 105, and a communication unit 106. These components are interconnected by buses. The main storage unit 102 and the auxiliary storage unit 103 are computer-readable recording media. The hardware configuration of the on-vehicle apparatus 100 is not limited to that illustrated in FIG. 3, but some components may be eliminated, replaced, or added.

The processor 101 of the on-vehicle apparatus 100 loads programs stored in a recording medium into a workspace of the main storage unit 102 and executes the programs to control various functional components of the on-vehicle apparatus 100. Thus, the on-vehicle apparatus 100 implements functions for achieving desired purposes.

The processor 101 may be, for example, a CPU (Central Processing Unit) or a DSP (Digital Signal Processor). The processor 101 controls the on-vehicle apparatus 100 and executes computation of various information processing. The main storage unit 102 may include a RAM (Random Access Memory), a ROM (Read Only Memory) and/or the like. The auxiliary storage unit 103 may include an EPROM (Erasable Programmable ROM) or a hard disk drive (HDD). The auxiliary storage unit 103 may include a removable medium, in other words, a portable recording medium. Examples of the removable medium include an USB (Universal Serial Bus) memory and disc recording media, such as a CD (Compact Disc) and a DVD (Digital Versatile Disc).

What is stored in the auxiliary storage unit 103 includes various programs, various data, and various tables, which can be written into and read out from the auxiliary storage unit 103 when necessary. The auxiliary storage unit 103 stores an operating system (OS) also. All or a portion of the aforementioned information or data stored in the auxiliary storage unit 103 may be stored in the main storage unit 102 instead. Likewise, information or data stored in the main storage unit 102 may be stored in the auxiliary storage unit 103 instead.

The input and output unit 104 is a device that receives inputting operations made by the driver of the taxi 10 and presents information to the driver, examples of which are the present location of the taxi 10 on a map and a planned route of travel from the present location to the recommended location of getting-in. The input and output unit 104 typically includes a touch panel display, a microphone, and a speaker.

The location determination unit 105 is a device capable of determining the present location of the on-vehicle apparatus 100 (that is, the present location of the taxi 10), which typically includes a GPS receiver.

The communication unit 106 is connected to the network N1 by wireless communication, such as mobile communication service to perform data communication with external devices including the server apparatus 300. The network N1 may be, for example, a WAN (Wide Area Network), which may be a global public communication network such as the Internet, or other communication network. The on-vehicle apparatus 100 in the system of this embodiment is connected to the network by wireless communication. Examples of the wireless communication include mobile communications, such as 5G (5th generation) mobile communications or LTE (Long Term Evolution) mobile communications. The wireless communication may be narrow-band communications, such as DSRC (Dedicated Short Range Communications) or WiFi (registered trademark).

Various processes executed by the on-vehicle apparatus 100 configured as above may be executed either by hardware or software.

The user's terminal 200 is a small computer that can be carried by the user, examples of which are a smartphone, a cellular phone, a tablet terminal, and a wearable computer. Alternatively, the user's terminal 200 may be a terminal provided in the home or a place of work of the user, an example of which is a personal computer connectable to the network N1.

As illustrated in FIG. 3, the user's terminal 200 has a processor 210, a main storage unit 202, an auxiliary storage unit 203, an input and output unit 204, a location determination unit 205, and a communication unit 206. These components are interconnected by buses. The processor 210, the main storage unit 202, the auxiliary storage unit 203, the input and output unit 204, the location determination unit 205, and the communication unit 206 are similar to the processor 101, the main storage unit 102, the auxiliary storage unit 103, the input and output unit 104, the location determination unit 105, and the communication unit 106 of the on-vehicle apparatus 100. The hardware configuration of the user's terminal 200 is not limited to that illustrated in FIG. 3, but some components may be eliminated, replaced, or added.

The server apparatus 300 has a configuration as an ordinary computer. As illustrated in FIG. 3, the server apparatus 300 has a processor 301, a main storage unit 302, an auxiliary storage unit 303, and a communication unit 304. These components are interconnected by busses. The processor 301, the main storage unit 302, and the auxiliary storage unit 303 are similar to the processor 101, the main storage unit 102, and the auxiliary storage unit 103 of the on-vehicle apparatus 100.

The communication unit 304 performs data communications between the server apparatus 300 and external devices. The communication unit 304 may include, for example, a LAN (Local Area Network) interface board or a wireless communication circuit for wireless communications. The LAN interface board or the wireless communication circuit is connected to the network N1. The hardware configuration of the server apparatus 300 is not limited to that illustrated in FIG. 3, but some components may be eliminated, replaced, or added.

Various processes executed by the server apparatus 300 configured as above may be executed either by hardware or software.

(Functional Configuration of Server Apparatus)

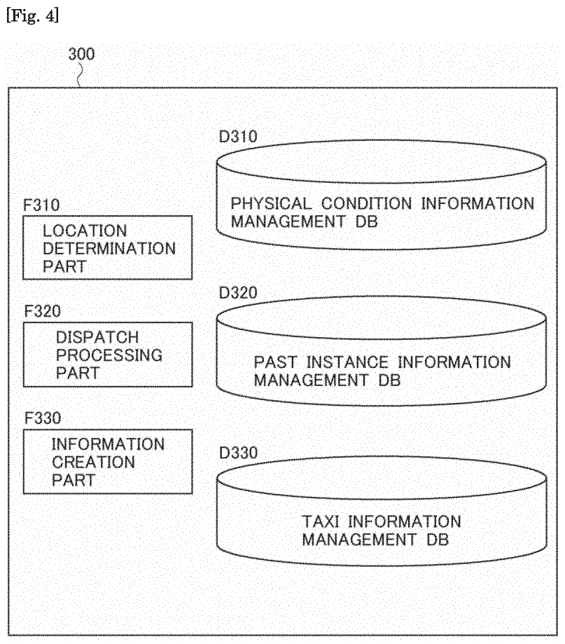

The functional configuration of the server apparatus 300 will now be described with reference to FIG. 4. As illustrated in FIG. 4, the server apparatus 300 includes, as functional components, a location determination part F310, an dispatch processing part F320, an information creation part F330, a physical condition information management database D310, a past instance information management database D320, and a taxi information management database D330.

The server apparatus 300 may implement the location determination part F310, the dispatch processing part F320, and the information creation part F330 by executing computer programs on the main storage unit 302 by the processor 301. The location determination part F310, the dispatch processing part F320, and the information creation part F330 jointly constitute the controller according to this disclosure. One or some of the location determination part F310, the dispatch processing part F320, and the information creation part F330 may be implemented by a hardware circuit(s).

The physical condition information management database D310, the past instance information management database D320, and the taxi information management database D330 are created by a database management system program (DBMS program) executed by the processor 301. Specifically, these three databases are created by managing data stored in the auxiliary storage unit 303 by the DBMS program. The physical condition information management database D310, the past instance information management database D320, and the taxi information management database D330 are, for example, relational databases.

One or some of the above functional components of the server apparatus 300 or a portion of the processing of them may be implemented by another computer connected to the network N1. For example, the processing executed as the location determination part F310, the processing executed as the dispatch processing part F320, and the processing executed as the information creation part F330 may be executed by different computers.

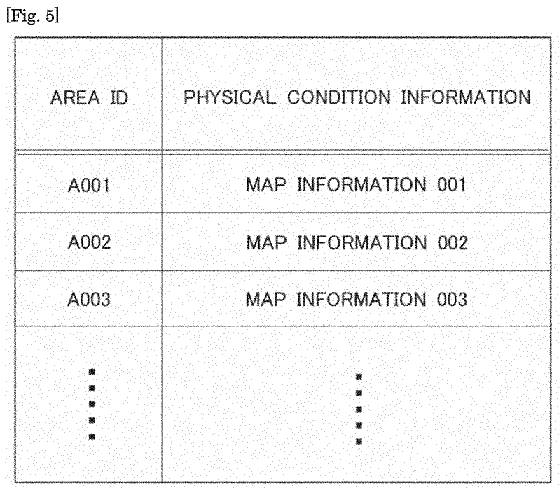

The physical condition management database D310 stores information (referred to as physical condition information) used to distinguish between places where it is physically possible for a user to get in a taxi 10 and places where it is physically impossible for a user to get in a taxi 10. The physical condition information is stored for each of the areas. More specifically, the coverage area over which the taxi dispatch service is provided is divided into a plurality of areas, and the physical condition information is stored for each of such areas. Each area is designed to have such a size that allows a user to move easily over it on foot or, for example, the maximum walking distance in each area will not exceed several meters or several tens of meters. An exemplary structure of the information stored in the physical condition information management database D310 will be described with reference to FIG. 5. FIG. 5 illustrates an exemplary table structure of the information stored in the physical condition information management database D310. It should be understood that the structure of the table stored in the physical condition information management database D310 (which will also be referred to as “physical condition information table” hereinafter) is not limited to that illustrated in FIG. 5, but some fields may be added, changed, or removed fitly.

The physical condition information table illustrated in FIG. 5 has the fields of area ID and physical condition information. What is stored in the area ID field is information (area ID) identifying each of the areas in the aforementioned coverage area. The area IDs stored in the area ID field are identifiers assigned to the respective areas when the aforementioned coverage area is divided into the areas. What is stored in the physical condition information field is road map information of each area. The road map information stored in the physical condition information field has markings at places where there is a “partition” between the road and the sidewalk and no-parking or no-stopping zones. The term “partition” used herein refers to a structure, such as a guardrail or planting, that partitions the road and the sidewalk and can prevent a user from moving from the sidewalk to the road. With the physical condition information table illustrated in FIG. 5, it is possible to distinguish between places where it is physically possible for users to get in taxis 10 and places where it is physically impossible for users to get in taxis 10 in the roads in each area. The places where it is physically possible for users to get in taxis 10 are places where there is no partition between the sidewalk and the road and that are not facing a no-parking or no-stopping zone. The places where it is impossible for users to get in taxis 10 are places where there is a partition between the sidewalk and the road or places that are facing a no-parking or no-stopping zone. The information stored in the physical condition information field is not limited to road map information, but it may be any information with which it is possible to distinguish between places where it is physically possible for users to get in taxis 10 and places where it is physically impossible for users to get in taxis 10.

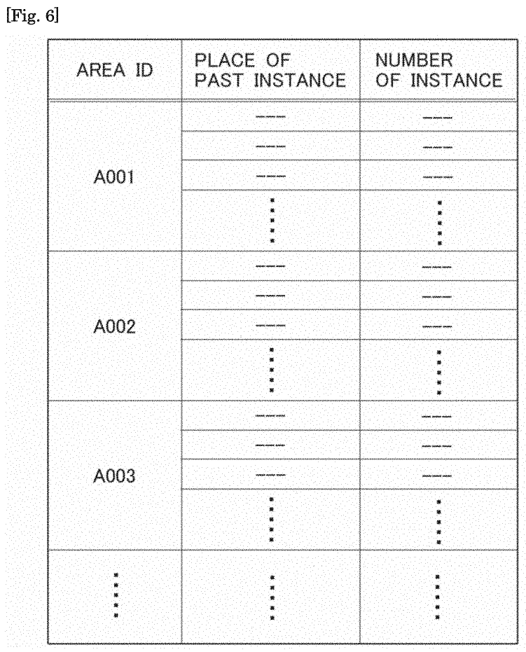

What is stored in the past instance information database D320 is past instance information, namely information about places where instances of users' getting in or getting out of taxis 10 actually took place in the past. This information is stored for each of the areas in the aforementioned coverage area. An exemplary structure of the information stored in the past instance information management database D320 will be described with reference to FIG. 6. FIG. 6 illustrates an exemplary table structure of the information stored in the past instance information management database D320. It should be understood that the structure of the table stored in the past instance information management database D320 (which will also be referred to as “past instance information table” hereinafter) is not limited to that illustrated in FIG. 6, but some fields may be added, changed, or removed fitly.

The past instance information table illustrated in FIG. 6 has the fields of area ID, place of past instances, and number of instances. What is stored in the area ID field is area IDs for identifying the respective areas in the aforementioned coverage area. The information stored in the area ID field of the past instance information table is the same as the information stored in the area ID field of the physical condition information table. What is stored in the place of past instances field is information about places of past instances, namely information about places where users' getting in and/or getting out of taxis 10 actually took place in each area. This information may be, for example, the addresses or the coordinates (i.e. latitude and longitude) on a map of the places of past instances. What is stored in the number of instances field is information indicating the number of instances of users' getting in and/or getting out of taxis 10 that actually took place at each place of past instances. In the areas in which there are a plurality of places of past instances, a plurality of place of past instances fields and a plurality of number of instances fields are linked with the area ID of each of the areas.

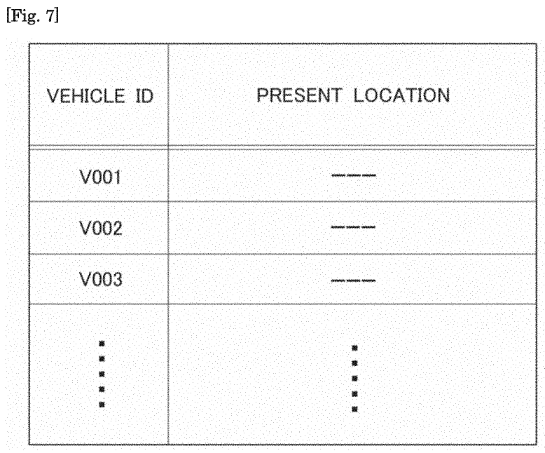

What is stored in the taxi information management database D330 is location information of taxis 10 (empty taxis 10). The taxi information management database D330 stores identification information of each taxi 10 and information about the present location thereof in a linked manner. An exemplary structure of the information stored in the taxi information management database D330 will be described with reference to FIG. 7. FIG. 7 illustrates an exemplary table structure of the information stored in the taxi information management database D330. It should be understood that the structure of the table stored in the taxi information management database D330 (which will also be referred to as “taxi information table” hereinafter) is not limited to that illustrated in FIG. 7, but some fields may be added, changed, or removed fitly.

The taxi information table illustrated in FIG. 7 has the fields of vehicle ID and present location. What is stored in the vehicle ID field is information (vehicle ID) for identifying each of the taxis 10 under the management of the server apparatus 300. What is stored in the present location field is information indicating the present location of each taxi 10. The information stored in the present location field may be, for example, information indicating the address of the place where each taxi 10 is located or information indicating the coordinates on a map of the location at which each taxi 10 is located. The information stored in the present location field is updated every time the server apparatus 300 receives location information sent from the on-vehicle apparatus 100 of each taxi 10 at regular intervals.

The location determination part F310 determines a recommended location of getting-in. This process of determination is triggered by the reception of a dispatch request signal from a user's terminal 200 by the communication unit 304 of the server apparatus 300. As described above, the recommended location of getting-in is a location appropriate for the user to get in a taxi 10. In the process of determining the recommended location of getting-in, the location determination part F310 firstly determines whether or not the desired location of getting-in is an appropriate place for the user to get in a taxi 10. Specifically, the location determination part F310 determines the area in which the desired location of getting-in is included. This area will be hereinafter referred to as the “specific area”. Then, the location determination part F310 accesses the physical condition information database to determine the physical condition information table associated with the specific area. Then, the location determination part F310 extracts the road map information stored in the physical condition information field of the physical condition information table determined as above. Then, the location determination part F310 compares the desired location of getting-in with the extracted road map information to determine whether or not it is physically possible for the user to get in a taxi 10 at the desired location of getting-in. In this process, the location determination part F310 determines that it is physically possible for the user to get in a taxi 10 at the desired location of getting-in, if there is no partition between the sidewalk and the road at the desired location of getting-in, and the desired location of getting-in is not facing a no-parking or no-stopping zone. If it is determined that it is physically possible for the user to get in a taxi 10 at the desired location of getting-in, the location determination part F310 determines whether or not there is a vehicle parked on the portion of the road adjacent to the desired location of getting-in. This process of determination is executed based on, for example, image data acquired by a surveillance camera provided near the road or image data acquired by a driving recorder of a taxi 10 running near the desired location of getting-in. Such image data or the like may be obtained using an external service. If it is determined that there is no vehicle parked on the portion of the road adjacent to the desired location of getting-in, it is determined that the desired location of getting-in is an appropriate place for the user to get in a taxi 10. Then, the location determination part F310 determines the desired location of getting-in as the recommended location of getting-in.

The location determination part F310 may determine whether or not the desired location of getting-in is an appropriate place for the user to get in a taxi 10 further taking into consideration at least one of the following two conditions in addition to the above-described conditions. In other words, the location determination part F310 may determine that the desired location of getting-in is an appropriate place for the user to get in a taxi 10, if the above-described conditions are met and at least one of the following conditions is met.

Condition 1: there is no traffic jam in any access road to the desired location of getting-in

Condition 2: there are no traffic restrictions in any access road to the desired location of getting-in

Information about traffic jams and traffic restrictions in an access road to the desired location of getting-in may be provided by a taxi 10 travelling in the neighborhood of the access road or obtained using an external service (e.g. a service that provides road traffic information).

If it is determined that it is physically impossible for the user to get in a taxi 10 at the desired location of getting-in, or if it is determined that there is a vehicle parked on the portion of the road adjacent to the desired location of getting-in, it is determined that the desired location of getting-in is not an appropriate place for the user to get in a taxi 10. Then, the location determination part F310 determines a place other than the desired location of getting-in as the recommended location of getting-in. Specifically, the location determination part F310 in the system of this embodiment selects as the recommended location of getting-in the place with the largest number of instances among the places allowing getting-in in the specific area, namely the places in the specific area where there is no partition between the sidewalk and the road and there is no parked vehicle and that are not facing a no-parking or no-stopping zone. In the process of determining the recommended location of getting in, the location determination part F310 firstly accesses the past instance information management database D320 to determine the past instance information table associated with the specific area. Then, the location determination part F310 determines the place with the largest number of instances (which will also be referred to as the “first candidate place” hereinafter) on the basis of the information stored in the number of instances field of the past instance information table determined as above. Then, the location determination part F310 compares the first candidate place with the road map information of the specific area to determine whether or not it is physically possible for the user to get in a taxi 10 at the first candidate place. If it is determined that it is physically possible for the user to get in a taxi 10 at the first candidate place, the location determination part F310 determines whether or not there is a vehicle parked on the portion of the road adjacent to the first candidate place. If it is determined that there is not a vehicle parked on the portion of the road adjacent to the first candidate place, the location determination part F310 determines the first candidate place as the recommended location of getting-in. In the case where it is determined that it is physically impossible for the user to get in a taxi 10 at the first candidate place, or it is determined that there is a vehicle parked on the portion of the road adjacent to the first candidate place, the location determination part F310 determines the place with the second largest number of instances after the first candidate place. This place with the second largest number of instances will also be referred to as the “second candidate place” hereinafter. Then, the location determination part F310 executes, for the second candidate place, a series of determination processes the same as the above-described processes executed for the first candidate place. The above series of determination processes is executed repeatedly until it is determined that a candidate place selected based on the past instance information is a place allowing getting-in. When a place appropriate for the user to get in a taxi 10 is determined in this way, the place is set as the recommended location of getting-in. As above, the place with the largest number of instances among the places allowing getting-in is determined as the recommended location of getting-in.

The dispatch processing part F320 executes dispatch processing (namely, the processing of dispatching a taxi 10) on the basis of the recommended location of getting-in determined by the location determination part F310. In the dispatch processing, the dispatch processing part F320 firstly determines the taxi 10 to be dispatched. The dispatch processing part F320 in the system of this embodiment selects the taxi 10 located closest to the recommended location of getting-in as the taxi to be dispatched. Specifically, the dispatch processing part F320 accesses the taxi information management database D330 to determine the taxi information table with the present location indicated by the information stored in the present location field of the taxi information table that is closest to the recommended location of getting-in. Then, the dispatch processing part F320 extracts the vehicle ID stored in the vehicle ID field of the taxi information table determined as above. Then, the dispatch processing part F320 determines the taxi 10 identified by the extracted vehicle ID as the taxi to be dispatched. The method of determining the taxi 10 to be dispatched is not limited to this. For example, the dispatch processing part F320 may calculate or predict the respective times at which taxis 10 will arrive at the recommended location of getting-in using information about traffic jams and traffic restrictions in the respective routes from the present locations of the taxis 10 to the recommended location of getting-in and selects the taxi 10 of which the predicted time of arrival is the earliest as the taxi to be dispatched.

After determining the taxi 10 to be dispatched, the dispatch processing part F320 determines a planned route of travel from the present location of this taxi 10 to the recommended location of getting-in. For example, the dispatch processing part F320 selects the route by which the taxi 10 is expected to arrive at the recommended location of getting-in earliest among the routes from the present location to the recommended location of getting-in as the planned route of travel.

After determining the planned route of travel of the taxi 10 to be dispatched, the dispatch processing part F320 creates a dispatch command. The dispatch command created in the system of this embodiment is a command that causes the on-vehicle apparatus 100 of the dispatched taxi 10 to provide route guidance based on the planned route of travel. The dispatch command contains information about the recommended location of getting-in and information about the planned route of travel. The dispatch command created by the dispatch processing part F320 is sent to the on-vehicle apparatus 100 of the taxi 10 to be dispatched through the communication unit 304.

The information creation part F330 creates getting-in location information. The getting-in location information is information used to invite the user to wait for the arrival of the taxi 10 at the recommended location of getting-in. The getting-in location information also has the role of informing the user of the system's acceptance of his/her request for dispatch of a taxi. The getting-in location information may include information about the expected time of arrival of the dispatched taxi 10. The getting-in location information created by the information creation part F330 is sent to the user's terminal 200 through the communication unit 304.

(Process Performed by Server Apparatus)

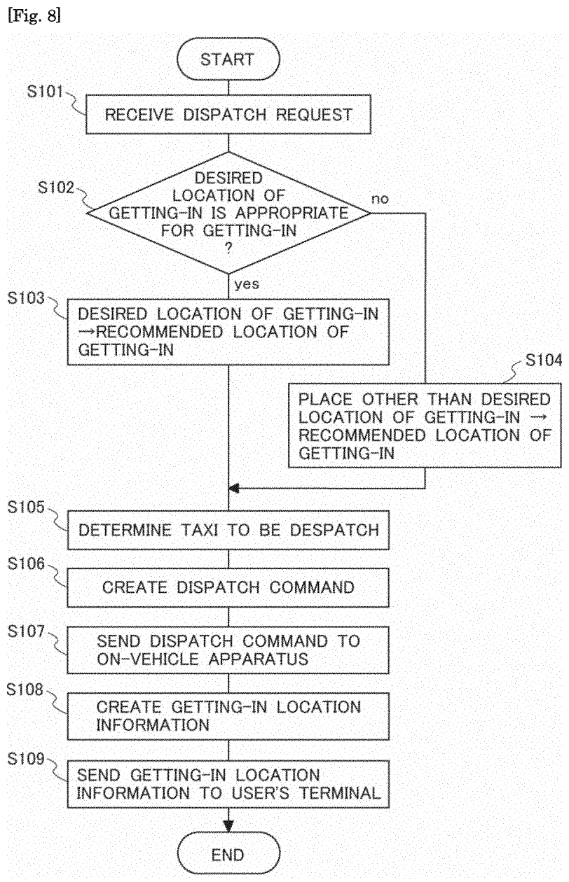

A process performed by the server apparatus 300 according to the embodiment will be described with reference to FIG. 8. FIG. 8 is a flow chart of the process performed by the server apparatus 300, which is triggered by reception of a dispatch request signal from a user's terminal 200.

In the process according to the flow chart of FIG. 8, when the communication unit 304 of the server apparatus 300 receives a dispatch request signal from a user's terminal 200 (step S101), the location determination part F310 determines whether or not the desired location of getting-in is an appropriate location for the user to get in a taxi 10 (step S102). Specifically, the location determination part F310 determines the area including the desired location of getting-in (specific area) and extracts road map information of the specific area from the physical condition information management database D310, as described above. Then, the location determination part F310 compares the desired location of getting-in with the extracted road map information to determine whether or not it is physically possible for the user to get in a taxi 10 at the desired location of getting-in. If it is determined that it is physically possible for the user to get in a taxi 10 at the desired location of getting-in, the location determination part F310 determines whether or not there is a vehicle parked on the portion of the road adjacent to the desired location of getting-in. If it is determined that there is not a vehicle parked on the portion of the road adjacent to the desired location of getting-in, the location determination part F310 determines that the desired location of getting-in is an appropriate place for the user to get in a taxi 10 (an affirmative answer in step S102). Then, the location determination part F310 determines the desired location of getting-in as the recommended location of getting-in (step S103).

In the case where it is determined that it is physically impossible for the user to get in a taxi 10 at the desired location of getting in, or it is determined that there is a vehicle parked on the portion of the road adjacent to the desired location of getting-in, the location determination part F310 determines that the desired location of getting-in is not an appropriate place for the user to get in a taxi 10 (a negative answer in step S102). Then, the location determination part F310 determines a place other than the desired location of getting-in as the recommended location of getting-in (step S104). Specifically, as described above, the location determination part F310 determines the place with the largest number of instances among the places allowing getting-in in the specific area on the basis of the past instance information stored in the past instance information management database D320 and the physical condition information stored in the physical condition information management database D310. Specifically, the location determination part F310 determines the place with the largest number of instances (i.e. the first candidate place) on the basis of the information stored in the place of past instances field and the number of instances field of the past instance information table associated with the specific area. Then, the location determination part F310 compares the first candidate place with the road map information stored in the physical condition information field of the physical condition information table associated with the specific area to determine whether or not it is physically possible for the user to get in a taxi 10 at the first candidate place. If it is determined that it is physically possible for the user to get in a taxi 10 at the first candidate place, then the location determination part F310 determines whether or not there is a vehicle parked on the portion of the road adjacent to the first candidate place. If it is determined that there is not a vehicle parked on the portion of the road adjacent to the first candidate place, the location determination part F310 determines the first candidate place as the recommended location of getting-in. In the case where it is determined that it is physically impossible for the user to get in a taxi 10 at the first candidate place, or it is determined that there is a vehicle parked on the portion of the road adjacent to the first candidate place, the location determination part F310 determines the place with the second largest number of instances after the first candidate place, which is the second candidate place. Then, the location determination part F310 executes, for the second candidate place, a series of determination processes the same as the above-described processes executed for the first candidate place. The above series of determination processes is executed repeatedly until it is determined that a candidate place selected based on the past instance information is a place allowing getting-in. When a place appropriate for the user to get in a taxi 10 is determined in this way, the place is set as the recommended location of getting-in.

Information about the recommended location of getting-in determined in step S103 or S104 is transferred from the location determination part F310 to the dispatch processing part F320. The dispatch processing part F320 determines the taxi 10 to be dispatched on the basis of the recommended location of getting-in (step S105). Specifically, as described above, the dispatch processing part F320 determines the taxi 10 located closest to the recommended location of getting-in on the basis of information stored in the taxi information management database D330. Then, the dispatch processing part F320 selects the taxi 10 thus determined as the taxi 10 to be dispatched.

After determining the taxi 10 to be dispatched, the dispatch processing part F320 creates a dispatch command (step S106). Specifically, as described above, the dispatch processing part F320 determines a planned route of travel from the present location of the taxi 10 to be dispatched to the recommended location of getting-in. Then, the dispatch processing part F320 creates a dispatch command based on the recommended location of getting-in and the planned route of travel. The dispatch command is a command to cause the on-vehicle apparatus 100 of the dispatched taxi 10 to provide route guidance based on the planned route of travel. The dispatch command contains information about the recommended location of getting-in and information about the planned route of travel. The dispatch command created by the dispatch processing part F320 is sent to the on-vehicle apparatus 100 of the taxi 10 to be dispatched through the communication unit 304 (step S107).

Information about the recommended location of getting-in determined in step S103 or S104 is transferred from the location determination part F310 to the information creation part F330 also. The information creation part F330 creates getting-in location information based on the recommended location of getting-in (step S108). As described above, the getting-in location information is information used to invite the user to wait for the arrival of the taxi 10 at the recommended location of getting-in. The getting-in location information created by the information creation part F330 is sent to the user's terminal 200 (step S109).

By the above process according to the flow chart of FIG. 8, the recommended location of getting-in is set at the place that has the largest number of instances among the places allowing getting-in in the area including the desired location of getting-in, namely the places where there is not a partition between the sidewalk and the road and there is no parked vehicle and that is not adjacent to a no-parking or no-stopping zone in the specific area. In other words, the recommended location of getting-in is set at a place that a taxi 10 can access and where it is physically possible for the user to get in a taxi 10 and it is convenient for the user to get in or get out of a taxi 10. This can prevent inconvenience of the user or increased effort of the driver of the taxi 10 from being incurred. Therefore, a taxi 10 can be dispatched efficiently.

### First Modification

In the case where it is determined that the desired location of getting-in is not an appropriate place for the user to get in a taxi 10, the system of the above-described embodiment sets the recommended location of getting-in at the place with the largest number of instances among the places allowing getting-in in the specific area. Alternatively, in the case where it is determined that the desired location of getting-in is not an appropriate place for the user to get in a taxi 10, the recommended location of getting-in may be set at the place with the least traffic jam in the access road thereto among the places allowing getting-in the specific area.

In the case where it is determined that the desired location of getting-in is not an appropriate place for the user to get in a taxi 10, the location determination part F310 in the system according to the first modification of the embodiment extracts the places allowing getting-in in the specific area. Then, the location determination part F310 obtains traffic jam information relating to the access road to each of the places allowing getting-in extracted as above. As described above, the traffic jam information may be obtained using an external service. Then, the location determination part F310 selects the place allowing getting-in with the least traffic jam in the access road thereto as the recommended location of getting-in. Thus, a place where it is physically possible for the user to get in a taxi 10 and that a taxi 10 can access quickly is determined as the recommended location of getting-in.

The system according to the first modification allows the user to get in a taxi 10 smoothly while minimizing the waiting time of the user and the time of travel of the taxi 10 that does not produce income for the taxi 10.

In the case where it is determined that the desired location of getting-in is not an appropriate place for the user to get in a taxi 10, the location determination part F310 may determine the recommended location of getting-in taking into consideration traffic restrictions in the access road in addition to traffic jam information relating to the access road. In this case, the location determination part F310 firstly extracts the places allowing getting-in with no traffic restrictions in the access road thereto from among the places allowing getting-in in the specific area. Then, the location determination part F310 may determine the place allowing getting-in with the least traffic jam in the access road thereto among the extracted places allowing getting-in as the recommended location of getting-in. This allows the user to get in a taxi 10 more smoothly while minimizing the waiting time of the user and the time of travel of the taxi 10 that does not produce income for the taxi 10 with improved reliability.

### Second Modification

In the case where it is determined that the desired location of getting-in is not an appropriate place for the user to get in a taxi 10, the system of the above-described embodiment determines the recommended location of getting-in without regard to the weather. Alternatively, in the case where it is determined that the desired location of getting-in is not an appropriate place for the user to get in a taxi 10, the recommended location of getting-in may be determined taking into consideration the weather.

In the case where it is determined that the desired location of getting-in is not an appropriate place for the user to get in a taxi 10, if the weather is bad, the location determination part F310 in the system according to the second modification selects a place from among the places allowing getting-in in a smaller area as the recommended location of getting-in. For example, the location determination part F310 sets the recommended location of getting-in at the place with the largest number of instances, the place with the least traffic jam in the access road thereto, or a place with no traffic restrictions in the access road thereto among the places allowing getting-in in the smaller area. The smaller area refers to an area that is smaller than the specific area and includes the desired location of getting-in. Alternatively, the location determination part F310 may set the recommended location of getting-in at the place allowing getting-in closest to the desired location of getting-in among the places allowing getting-in in the specific area. In the case where it is determined that the desired location of getting-in is not an appropriate place for the user to get in a taxi 10, if the weather is fine, the recommended location of getting-in may be determined by the method employed in the system according to the above-described embodiment or the first modification. In the context of the second modification, the “bad weather” refers to rain, snow, or strong wind.

The system according to the second modification can make the distance over which the user is obliged to walk in bad weather as small as possible in the case where it is determined that the desired location of getting-in is not an appropriate place for the user to get in a taxi 10.

### Third Modification

In cases where train operations are suspended or delayed, a plurality of users located in the neighborhood of a station may make requests for dispatch of taxis in a short period of time. In cases where a gathering (such as a sporting event, a concert, an exhibition, or a festival etc.) is being held, a plurality of users located in the neighborhood of the venue of the gathering may make requests for dispatch of taxis in a short period of time. In such cases, the server apparatus 300 will receive a plurality of dispatch request signals designating desired locations of getting-in located in a specific area in a short period of time. In such cases, if the recommended locations of getting-in that are set in response to at least two of the plurality of dispatch request signals coincide with each other, it can be difficult for the users to get in taxis 10 smoothly.

To avoid the above situations, in the case where the server apparatus 300 receives a plurality of dispatch request signals designating desired locations of getting-in located in a specific area in a short period of time, the location determination part F310 may set the recommended locations of getting-in answering to the plurality of dispatch request signals at places different from each other. For example, in the case where it is determined that a desired location of getting-in is an appropriate place for the user to get in a taxi 10, the location determination part F310 determines or checks whether or not the desired location of getting-in is being set as a recommended location of getting-in answering to another dispatch request signal. In other words, the location determination part F310 determines whether or not a user associated with another dispatch request signal is waiting at the desired location of getting-in. If the desired location of getting-in is being set as a recommended location of getting-in answering to another dispatch request signal, the location determination part F310 sets a place other than the desired location of getting-in (e.g. the place with the largest number of instances among the places allowing getting-in in the specific area) as the recommended location of getting-in. In the case where it is determined that the desired location of getting-in is not an appropriate place for the user to get in a taxi 10, after determining the place with the largest number of instances among the places allowing getting-in in the specific area, the location determination part F310 determines whether or not the place with the largest number of instances is being set as a recommended location of getting-in answering to another dispatch request signal. If the place with the largest number of instances is being set as a recommended location of getting-in answering to another dispatch request signal, the location determination part F310 may set a place other than the place with the largest number of instances (e.g. the place with the second largest number of instances) as the recommended location of getting-in.

In the case where the server apparatus 300 receives a plurality of dispatch request signals designating desired locations of getting-in located in a specific area in a short period of time, the system of this modification can prevent the recommended locations of getting-in answering to the plurality of dispatch request signals from coinciding with each other. In other words, the system of this modification can disperse the recommended locations of getting-in answering to the plurality of dispatch request signals. In consequence, the users associated with the plurality of dispatch request signals can get in dispatched taxis 10 smoothly.

### Fourth Modification

A dispatch request signals sent from the user's terminal 200 may contain information about a destination at which the user wishes to get out of the taxi 10 in some cases. In such cases, the recommended location of getting-in may be determined taking into consideration the direction of traffic of lanes that is convenient for the taxi 10 to travel from the specific area to the destination.

In the process of determining the recommended location of getting-in, the system of the fourth modification firstly determines whether or not the lane adjacent to the desired location of getting-in is an appropriate lane, in addition to whether or not it is physically possible for the user to get in a taxi 10 at the desire location of getting-in, and whether or not there is a vehicle parked on the portion of the road adjacent to the desired location of getting-in. The term “appropriate lane” refers to a lane whose direction of traffic is appropriate or convenient for the taxi 10 to travel from the specific area to the destination. If it is physically possible for the user to get in a taxi 10 at the desired location of getting-in, there is no vehicle parked on the portion of the road adjacent to the desired location of getting-in, and the lane adjacent to the desired location of getting-in is an appropriate lane, the location determination part F310 determines the desired location of getting-in as the recommended location of getting-in. If at least one of the above three conditions is not met, the location determination part F310 determines a place other than the desired location of getting-in as the recommended location of getting-in. For example, the location determination part F310 determines a place adjacent to an appropriate lane among the places allowing getting-in in the specific area, as the recommended location of getting-in. In the case where there is a plurality of places allowing getting-in that are adjacent to an appropriate lane, the recommended location of getting-in may be set at the place with the largest number of instances, the place with the least traffic jam in the access road thereto, a place with no traffic restrictions in the access road thereto, or the place closest to the desired location of getting-in.

The system of this modification eliminates the need for a U-turn of the taxi 10 after the user's getting in the taxi 10, thereby preventing an unnecessary increase in the taxi fare.

### Fifth Modification

There may be cases where a gathering, such as a sporting event, a concert, an exhibition, or a festival, is being held in a facility near the desired location of getting-in. In such cases, people who wish to take taxis may concentrate in the area around the desired location of getting-in. In such cases, many taxis may gather in the area near the desired location of getting-in. This can prevent the dispatched taxi 10 from quickly accessing the desired location of getting-in or the user from getting in the dispatched taxi 10 smoothly. To prevent such situations from occurring, when a gathering is being held in a facility near the desired location of getting-in, the system of this modification sets the recommended location of getting-in at a place selected from among “places of past temporary instances”. The term “place of past temporary instances” refers to places where instances of users' getting in and/or getting out of taxis 10 actually took place during periods in which gatherings were being held in the past.

(Functional Configuration of Server Apparatus)

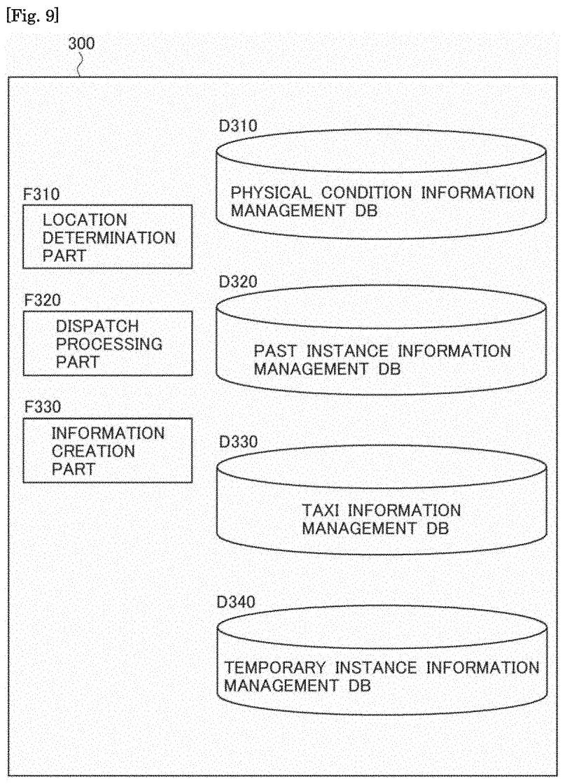

The functional configuration of the server apparatus 300 in the system according to the fifth modification will now be described with reference to FIG. 9. As illustrated in FIG. 9, the server apparatus 300 according to this modification includes, as its functional components, a temporary instance information management database D340 in addition to the location determination part F310, the dispatch processing part F320, the information creation part F330, the physical condition information management database D310, the past instance information management database D320, and the taxi information management database D330.

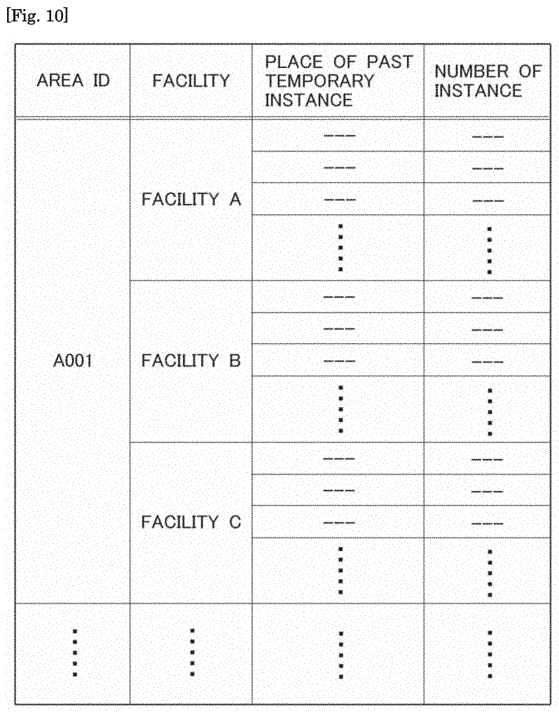

The temporary instance information management database D340 is a relational database created by managing data stored in the auxiliary storage unit 303 by the DBMS program. The temporary instance information management database D340 constitutes the storage unit defined in this disclosure. The temporary instance information management database D340 stores information about the places of past temporary instances in the periods during which gatherings were held in facilities, such as event halls, open spaces, sports parks, and exhibition halls. The temporary instance information database D340 links facilities and places of past temporary instances with each other. An exemplary structure of the information stored in the temporary instance information management database D340 will be described with reference to FIG. 10. FIG. 10 illustrates an exemplary table structure of the information stored in the temporary instance information management database D340. It should be understood that the structure of the table stored in the temporary instance information management database D340 (which will also be referred to as “temporary instance information table” hereinafter) is not limited to that illustrated in FIG. 10, but some fields may be added, changed, or removed fitly.

The temporary instance information table illustrated in FIG. 10 has the fields of area ID, facility, place of past temporary instances, and number of instances. What is stored in the area ID field is the area IDs for identifying the respective areas in the aforementioned coverage area. The information stored in the area ID field of the temporary instance information table is the same as the information stored in the area ID field of the physical condition information table and the information stored in the area ID field of the past instance information table. What is stored in the facility field is information for identifying each of the facilities located in each area (e.g. the name of each facility). In the case where there are a plurality of facilities in an area, a plurality of facility fields are linked with the area ID of that area. What is stored in the place of past temporary instances field is information about the places of past temporary instances linked with each facility, which may be, for example, the addresses or the coordinates on a map of the places. What is stored in the number of instances field is information indicating the number of instances of users' getting in and/or getting out of taxis 10 that actually took place at each place of past temporary instances. If there are a plurality of places of past temporary instances near a facility, a plurality of place of past temporary instances fields and a plurality of number of instances fields are linked with the facility field of that facility.

In determining the recommended location of getting-in, the location determination part F310 of this modification firstly determines whether or not a gathering is being held in some facility located in the specific area including the desired location of getting-in. The location determination part F310 may determine whether or not a gathering is being held in some facility on the basis of the schedule of gatherings held in the facilities. The schedule of gatherings may be obtained from, for example, web sites of the facilities or using an external service that provides the schedule of gatherings held in the facilities.

If it is determined that a gathering is not held in any facility, the location determination part F310 may determine the recommended location of getting-in in the same manner as the above-described embodiment or one of the first to fourth modifications. On the other hand, if it is determined that a gathering is being held in a facility, the location determination part F310 accesses the temporary instance information management database D340 to extract the place of past temporary instances that has the largest number of instances among the places of past temporary instances linked with the facility. Then, the location determination part F310 determines the place of past temporary instances thus extracted as the recommended location of getting-in. Alternatively, the location determination part F310 may determine the place of past temporary instances with the least traffic jam in the access road thereto among the places of past temporary instances linked with the facility as the recommended location of getting-in. Alternatively, the location determination part F310 may determine a place of past temporary instances with no traffic restrictions in the access road thereto among the places of past temporary instances linked with the facility as the recommended location of getting-in. Alternatively, the location determination part F310 may determine the place of past temporary instances closest to the desired location of getting-in among the places of past temporary instances linked with the facility as the recommended location of getting-in.

(Process Performed by Server Apparatus)

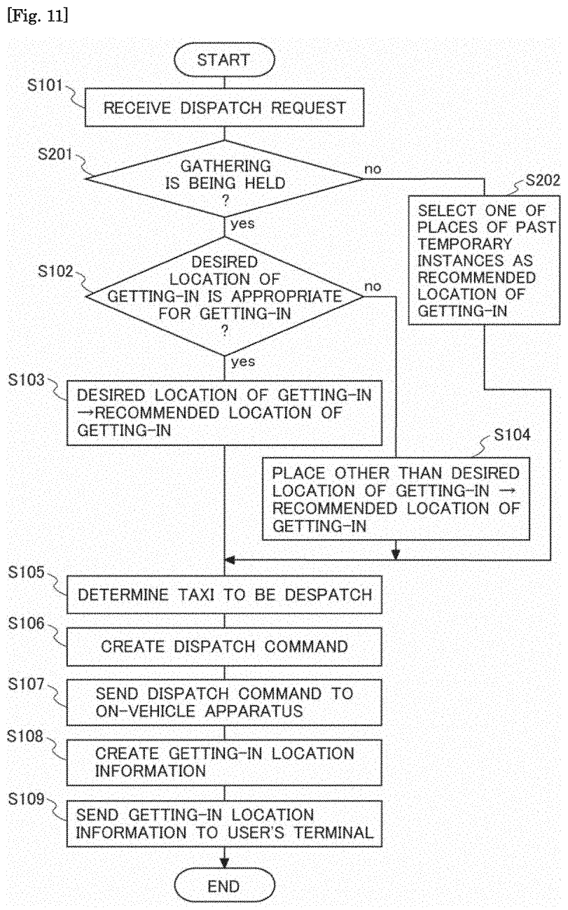

A process performed by the server apparatus 300 according to the fifth modification will be described with reference to FIG. 11. FIG. 11 is a flow chart of the process performed by the server apparatus 300, which is triggered by reception of a dispatch request signal from a user's terminal 200. In FIG. 11, the processing steps the same as the processing steps in the process according to the flow chart of FIG. 8 are denoted by the same reference signs.

In the process according to the flow chart of FIG. 11, when the communication unit 304 of the server apparatus 300 receives a dispatch request signal sent from a user's terminal 200 (step S101), the location determination part F310 determines whether or not a gathering is being held in some facility in the specific area (step S201). Specifically, the location determination part F310 determines whether or not a gathering is being held in some facility on the basis of the schedule of gatherings held in the facilities located in the specific area, as described above. If a gathering is not being held in any facility in the specific area (a negative answer in step S201), the location determination part F310 executes the processing of steps S102 to S104. In other words, the location determination part F310 determines the recommended location of getting-in in the same manner as the above-described embodiment. Then, the processing of steps S105 to S109 is executed in the same manner as the above-described embodiment.

If a gathering is being held in a facility in the specific area (an affirmative answer in step S201), the location determination part F310 selects one of the places of past temporary instances linked with the facility as the recommended location of getting-in (step S202). Specifically, the location determination part F310 accesses the temporary instance information management database D340 to extract the place of past temporary instances that has the largest number of instances among the places of past temporary instances linked with the facility. Then, the location determination part F310 determines the place of past temporary instances extracted as above as the recommended location of getting-in. After the processing of step S202 is executed, the processing of steps S105 to S109 is executed in the same manner as the above-described embodiment.

In the period during which a gathering is being held in the specific area, the system of this modification sets the recommended location of getting-in at a place that is convenient for the user to get in and out of a taxi 10 and easy to access for a taxi 10. This allows the user to get in a taxi 10 smoothly even in the period during which a gathering is being held in the specific area.

In the period during which a gathering is being held in a facility in the specific area, the server apparatus 300 may receive a plurality of dispatch request signals designating desired locations of getting-in located in the specific area in a short period of time, as described in the description of the third modification. If the place of past temporary instances extracted by the location determination part F310 as above is the recommended location of getting-in set in response to another dispatch request signal, a place of past temporary instances other than the place of past temporary instances extracted as above may be set as the recommended location of getting-in. Thus, the system of this modification can disperse the recommended locations of getting-in, thereby allowing the user to get in a taxi 10 smoothly.

### Others

The above embodiments and modifications have been described only by way of example. Modifications can be made to the above embodiments without departing from the essence of this disclosure. For example, some features of the above-described embodiment and modifications may be employed in any possible combination.

The processing and means that have been described in the foregoing may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (or information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of the computer-readable, non-transitory storage medium include any type of disc medium including a magnetic disc, such as a floppy disc (registered trademark) and a hard disk drive (HDD), and an optical disc, such as a CD-ROM, a DVD and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus comprising a controller including at least one processor,
the controller configured to execute the processing of:
receiving a dispatch request signal from a user's terminal used by a user, the dispatch request signal being a signal requesting dispatch of a taxi and containing information about a desired location of getting-in at which the user wishes to get in a taxi;
determining a recommended location of getting-in on the basis of at least one of physical condition information defined as information about a physical condition relating to a road in a specific area including the desired location of getting-in, past instance information defined as information about instances of users' getting in and/or getting out of taxis that took place in the specific area in the past, and road information defined as information about a condition of the road in the specific area; and
sending getting-in location information to the user's terminal, the getting-in location information being information for inviting the user to wait at the recommended location of getting-in.

2. An information processing apparatus according to claim 1, wherein the physical condition information includes at least one of information about a place in the specific area where a partition separating the sidewalk and the road is provided and information about a no-parking or no-stopping zone in the specific area.

3. An information processing apparatus according to claim 2, wherein the past instance information includes information about a place of past instances defined as a place in the specific area where instances of users' getting in and/or getting out of taxis actually took place in the past and information about the number of instances of users' getting in and/or getting out of taxis that actually took place at the place of past instances in the past.

4. An information processing apparatus according to claim 3, wherein the road information includes at least one of information about traffic jams in the specific area, information about whether or not there is a vehicle parked in the specific area, information about traffic restrictions in a road in the specific area, and information about whether or not a gathering is being held in the specific area.

5. An information processing apparatus according to claim 4, wherein the controller is configured to execute the processing of:
determining whether or not the desired location of getting-in is an appropriate place for the user to get in a taxi on the basis of at least one of the physical condition information, the past instance information, and the road condition information; and
determining the desired location of getting-in as the recommended location of getting-in, if it is determined that the desired location of getting-in is an appropriate place for the user to get in a taxi.

6. An information processing apparatus according to claim 5, wherein if it is determined that the desired location of getting-in is not an appropriate place for the user to get in a taxi, the controller determines the place with the largest number of instances among places allowing getting-in as the recommended location of getting-in, the places allowing getting-in being defined as places where there is no partition between the places and the road adjacent thereto and there is no parked vehicle and that do not face a no-parking or no-stopping zone.

7. An information processing apparatus according to claim 5, wherein if it is determined that the desired location of getting-in is not an appropriate place for the user to get in a taxi, the controller determines the place with the least traffic jam among places allowing getting-in as the recommended location of getting-in, the places allowing getting-in being defined as places where there is no partition between the places and the road adjacent thereto and there is no parked vehicle and that do not face a no-parking or no-stopping zone.

8. An information processing apparatus according to claim 6, wherein the controller selects the recommended location of getting-in from among locations allowing getting in that are closer to the desired location of getting-in when the weather is bad than when the weather is fine.

9. An information processing apparatus according to claim 5, wherein when the controller receives a plurality of dispatch request signals with desired locations of getting-in located in the specific area in a short period of time, the controller sets the recommended locations of getting-in for the plurality of dispatch request signals at places different from each other.

10. An information processing apparatus according to claim 1, wherein the dispatch request signal further contains information about a destination to which the user wishes to go, and the controller determines the recommended location of getting-in on the basis of the direction of traffic of lanes that is convenient for a taxi to travel from the specific area to the destination in addition to at least one of the physical condition information, the past instance information, and the road information.

11. An information processing apparatus according to claim 1, further comprising a storage unit in which information about a facility located in the specific area where a gathering can be held and information about places of past temporary instances are stored in a linked manner, the places of past temporary instances being defined as places in the specific area where instances of users' getting in and/or getting out of taxis actually took place in a period during which a gathering was being held in the past, and in the period during which a gathering is being held in the facility, the controller selects the recommended location of getting-in from among the places of past temporary instances.

12. An information processing method comprising the following steps of processing executed by a computer:
receiving a dispatch request signal from a user's terminal used by a user, the dispatch request signal being a signal requesting dispatch of a taxi and containing information about a desired location of getting-in at which the user wishes to get in a taxi;
determining a recommended location of getting-in on the basis of at least one of physical condition information defined as information about a physical condition relating to a road in a specific area including the desired location of getting-in, past instance information defined as information about instances of users' getting in and/or getting out of taxis that took place in the specific area in the past, and road information defined as information about a condition of the road in the specific area; and
sending getting-in location information to the user's terminal, the getting-in location information being information for inviting the user to wait at the recommended location of getting-in.

13. An information processing method according to claim 12, wherein the physical condition information includes at least one of information about a place in the specific area where a partition separating the sidewalk and the road is provided and information about a no-parking or no-stopping zone in the specific area.

14. An information processing method according to claim 13, wherein the past instance information includes information about a place of past instances defined as a place in the specific area where instances of users' getting in and/or getting out of taxis actually took place in the past and information about the number of instances of users' getting in and/or getting out of taxis that actually took place at the place of past instances in the past.

15. An information processing method according to claim 14, wherein the road information includes at least one of information about traffic jams in the specific area, information about whether or not there is a vehicle parked in the specific area, information about traffic restrictions in a road in the specific area, and information about whether or not a gathering is being held in the specific area.

16. An information processing method according to claim 15, wherein the step of determining the recommended location of getting-in comprises the steps of:
determining whether or not the desired location of getting-in is an appropriate place for the user to get in a taxi on the basis of at least one of the physical condition information, the past instance information, and the road condition information; and
determining the desired location of getting-in as the recommended location of getting-in, if it is determined that the desired location of getting-in is an appropriate place for the user to get in a taxi.

17. An information processing method according to claim 16, wherein the step of determining the recommended location of getting-in comprises the step of determining, if it is determined that the desired location of getting-in is not an appropriate place for the user to get in a taxi, the place with the largest number of instances among places allowing getting-in as the recommended location of getting-in, the places allowing getting-in being defined as places where there is no partition between the places and the road adjacent thereto and there is no parked vehicle and that do not face a no-parking or no-stopping zone.

18. An information processing method according to claim 16, wherein the step of determining the recommended location of getting-in comprises the step of determining, if it is determined that the desired location of getting-in is not an appropriate place for the user to get in a taxi, the place with the least traffic jam among places allowing getting-in as the recommended location of getting-in, the places allowing getting-in being defined as places where there is no partition between the places and the road adjacent thereto and there is no parked vehicle and that do not face a no-parking or no-stopping zone.

19. An information processing method according to claim 12, wherein the computer has a storage unit in which information about a facility located in the specific area where a gathering can be held and information about places of past temporary instances are stored in a linked manner, the places of past temporary instances being defined as places in the specific area where instances of users' getting in and/or getting out of taxis actually took place in a period during which a gathering was being held in the past, and in the period during which a gathering is being held in the facility, the recommended location of getting-in is selected from among the places of past temporary instances in the step of determining the recommended location of getting-in.

20. A non-transitory storage medium in which an information processing program for causing a computer to implement an information processing method according to claim 12.
